(19) United States
(12) Patent Application Publication
(10) Pub. No.: US 2022/0187773 A1
(43) Pub. Date: Jun. 16, 2022

(54) MANAGING ENERGY USING ARTIFICIAL INTELLIGENCE

(71) Applicant: Micron Technology, Inc., Boise, ID (US)

(72) Inventors: Kathryn H. Russo, Boise, ID (US); Fatma Arzum Simsek-Ege, Boise, ID (US); Yixin Yan, Boise, ID (US); Gitanjali T. Ghosh, Boise, ID (US); Libo Wang, Boise, ID (US)

(21) Appl. No.: 17/120,391

(22) Filed: Dec. 14, 2020

(51) Int. Cl. G05B 13/02; G08C 17/02; G05B 13/04; H02J 3/38; H02J 13/00

(52) U.S. Cl. CPC G05B 13/0265; G08C 17/02; G08C 2201/30; H02J 3/381; H02J 13/00022; G05B 13/048

(57) ABSTRACT

Methods, devices, and systems related to managing energy using artificial intelligence (AI) are described. In an example, a method can include receiving first signaling including data representing an energy input at a processing resource of a computing device from a radio in communication with a processing resource of an energy source, receiving second signaling including user data at the processing resource of the computing device from a memory of the computing device, inputting the user data and the data representing the energy input into an AI model at the processing resource of the computing device, generating data representing a command as an output of the AI model, and transmitting third signaling including the data representing the command to the processing resource of the energy source from the processing resource of the computing device via the radio in communication with the processing resource of the energy source.

### TECHNICAL FIELD

The present disclosure relates generally to managing energy using artificial intelligence (AI).

### BACKGROUND

A building can include an electrical system. An electrical system can distribute electrical power to loads around a building that consume electrical energy. An electrical system can receive an energy input from a number of energy sources. For example, energy sources can include petroleum, hydrocarbon gas liquids, natural gas, coal, nuclear energy, solar energy, geothermal energy, wind energy, biomass, and hydropower. Some energy sources may be preferred over other energy sources due to cost and/or environmental impact.

### BRIEF DESCRIPTION OF THE DRAWINGS

FIG. 1 illustrates an example of a computing device for managing energy in accordance with a number of embodiments of the present disclosure.

FIG. 2 illustrates an example of a system for managing energy in accordance with a number of embodiments of the present disclosure.

FIG. 3 is a flow diagram of a method for managing energy in accordance with a number of embodiments of the present disclosure.

### DETAILED DESCRIPTION

The present disclosure includes methods, apparatuses, and systems related to receiving first signaling including data representing an energy input at a processing resource of a computing device from a radio in communication with a processing resource of an energy source, receiving second signaling including user data at the processing resource of the computing device from a memory of the computing device, inputting the user data and the data representing the energy input into an artificial intelligence (AI) model at the processing resource of the computing device, generating data representing a command as an output of the AI model at the processing resource of the computing device, and transmitting third signaling including the data representing the command to the processing resource of the energy source from the processing resource of the computing device via the radio in communication with the processing resource of the energy source in response to generating the data representing the command as the output of the AI model

The energy source can be, for example, an electrical grid, a battery, a wind turbine, or a solar panel. Energy sources can provide data representing an energy input to the computing device, which can include the type of energy source, amount of available energy, and/or the historical (e.g., past), current, and/or predicted (e.g., future) cost of the energy.

In some examples, the computing device can be a smart assistant (e.g., Amazon Alexa, Google Nest, etc.), a wearable device, a smartphone, a tablet, a laptop, a desktop computer, or any combination thereof. The computing device can receive the data representing the energy input from one or more energy sources and input the data representing the energy input into an AI model. In a number of embodiments, additional and/or different data can be inputted into the AI model. For example, user data, data representing user constraints, electrical system data, data representing news related to local energy consumption, and/or weather data can be inputted into the AI model. The AI model can predict energy usage, predict an amount of energy of the energy input prior to receiving data representing the energy input, determine which energy source to directly use, generate recommendations and/or generate commands and output the prediction, determination, recommendations, and/or commands as a result.

A command can include transmitting an energy input, adjusting an allocation of energy, adjusting a setting of an energy source, and/or adjusting a setting of an electrical system. The command can be transmitted to an energy source, an electrical system, a heating, ventilation, and air conditioning (HVAC) system, an appliance, an electronic device, a vehicle, a light, a security system, a watering system, a plumbing system, a sewer system, and/or a septic system, for example.

As used herein, “a number of” something can refer to one or more of such things. For example, a number of energy sources can refer to one or more energy sources. A “plurality” of something intends two or more. Additionally, designators such as “X”, as used herein, particularly with respect to reference numerals in the drawings, indicates that a number of the particular feature so designated can be included with a number of embodiments of the present disclosure.

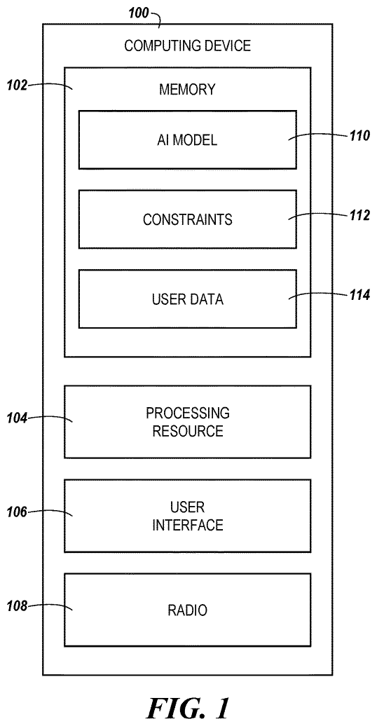

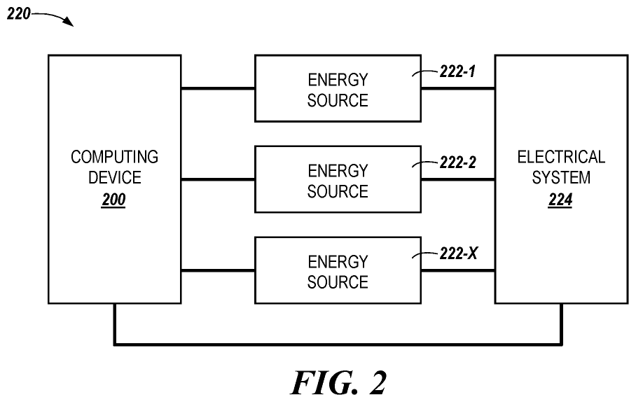

The figures herein follow a numbering convention in which the first digit or digits correspond to the drawing figure number and the remaining digits identify an element or component in the drawing. Similar elements or components between different figures may be identified by the use of similar digits. For example, reference numeral 100 may reference element “0” in FIG. 1, and a similar element may be referenced as 200 in FIG. 2. In some instances, a plurality of similar, but functionally and/or structurally distinguishable, elements or components in the same figure or in different figures may be referenced sequentially with the same element number (e.g., 222-1, 222-2, and 222-X in FIG. 2). As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of a computing device 100 for managing energy in accordance with a number of embodiments of the present disclosure. The computing device 100 can be, but is not limited to, a wearable device, a smartphone, a tablet, a laptop, a desktop computer, or any combination thereof. The computing device 100, as illustrated in FIG. 1, can include a memory 102, a processing resource 104, a user interface 106, and a radio 108.

In some examples, the memory 102 can store an AI model 110, user defined constraints 112, user data 114, among other data. The memory 102 can be coupled to the processing resource 104 and the memory 102 can be any type of storage medium that can be accessed by the processing resource 104 to perform various examples of the present disclosure. For example, the memory 102 can be a non-transitory computer readable medium having computer readable instructions (e.g., computer program instructions) stored thereon that are executable by the processing resource 104 to receive first signaling including data representing an energy input at the processing resource 104 of the computing device 100 from the radio 108 in communication with the processing resource of an energy source, receive second signaling including user data 114 at the processing resource 104 of the computing device 100 from the memory 102 of the computing device 100, input the user data 114 and the data representing the energy input into the AI model 110 at the processing resource 104 of the computing device 100, generate data representing a command as an output of the AI model 110 at the processing resource 104 of the computing device 100, and transmit third signaling including the data representing the command to the processing resource of the energy source from the processing resource 104 of the computing device 100 via the radio 108 in communication with the processing resource of the energy source in response to generating the data representing the command as the output of the AI model 110.

The processing resource 104 can include components configured to enable the computing device 100 to perform AI operations. In some examples, AI operations may include training operations or interference operations, or both. In a number of embodiments, the AI model 110 can be trained remotely in a cloud using sample data and transmitted to the computing device 100.

Data representing user defined constraints 112, electrical system data, data representing news related to local energy consumption, and/or weather data can also be inputted into the AI model 110 along with the user data 114 and the energy input data. The energy input data can include the type of energy source, amount of available energy, and/or the historical, current, and/or predicted cost of the energy. The user data 114 can include, but is not limited to, the amount of energy consumption and/or the frequency of energy consumption of a building, an electrical system, a vehicle, an appliance, an HVAC system, an appliance, a light, a security system, a watering system, a plumbing system, a sewer system, a septic system, and/or an electronic device. The electrical system data can include an amount of energy consumed and/or times of energy consumption of an electrical system. Forecasts and/or historical weather patterns can be included in weather data. In some examples, a user can input (e.g., select) user defined constraints 112, such as, an energy spending budget, an energy source preference, excess energy allocation, or a battery target level.

The user defined constraints 112 can be inputted via user interface 106. The user interface 106 can be generated by computing device 100 in response to one or more commands. The user interface 106 can be a graphical user interface (GUI) that can provide and/or receive information to and/or from the user of the computing device 100. In a number of embodiments, the user interface 106 can be shown on a display of the computing device 100.

In a number of embodiments, the computing device 100 can convey recommendations to users via user interface 106 and/or transmit recommendations to a user via text messages and/or email, for example. The AI model 110 can generate the recommendations based on data representing energy input, user data 114, data representing user defined constraints 112, electrical system data, data representing news related to local energy consumption, and/or weather data. For example, the AI model 110 can determine that the user is consuming more energy than one or more energy sources are producing or the AI model 110 can predict an impending energy shortage. In response to the determination, the computing device 100 can display on the user interface 106 and/or transmit a recommendation to the user. The computing device 100 can recommend using less energy and/or turning off a particular electronic device consuming energy needed to continue to power the rest of the home, for example. The recommendations, data representing energy input, user data 114, data representing user defined constraints 112, electrical system data, data representing news related to local energy consumption, and or weather data can be displayed on user interface 106.

The computing device 100 can receive and/or transmit data, recommendations, and/or commands via a communication device. The communication device can be, but is not limited to, a radio 108. Computing device 100 can receive data representing energy input, data representing user defined constraints 112, data representing news related to local energy consumption, weather data, and/or electrical system data and transmit commands via signaling. As used herein, signaling can include a communication (e.g., a radio signal) that carries data from one location to another. For example, signaling including data can be transmitted between computing device 100, one or more other computing devices, cloud computing devices, energy sources, electrical systems, HVAC systems, appliances, electronic devices, vehicles, lights, security systems, watering systems, plumbing systems, septic systems, and/or sewer systems.

FIG. 2 illustrates an example of a system 220 for managing energy in accordance with a number of embodiments of the present disclosure. The system 220 can include a computing device 200, which can correspond to computing device 100 in FIG. 1, a number of energy sources 222-1, 222-2, . . . , 222-X, and an electrical system 224. The computing device 220 can be a wearable device, a smartphone, a tablet, a laptop, a desktop computer, or any combination thereof and can include a memory, a processing resource, a user interface, and a radio, as previously described in connection with FIG. 1.

Each of the number of energy sources 222-1, 222-2, . . . , 222-X can provide energy to the electrical system 224. The electrical system 224 can be and/or can include an HVAC system, an appliance, an electronic device, a vehicle, a light, a security system, a watering system, a plumbing system, a sewer system, a septic system, and/or any combination thereof. Electrical system 224 can be included in a building, a property, or a vehicle, for example. An electrical system 224 can distribute electrical power to loads around a building, a property, or a vehicle that consume electrical energy. An electrical system 224 can receive an energy input from the number of energy sources 222-1, 222-2, . . . , 222-X.

In a number of embodiments, the energy sources 222-1, 222-2, . . . , 222-X can be different types of energy. For example, an energy source of the number of energy sources 222-1, 222-2, . . . , 222-X can be an electrical grid, a battery, a wind turbine, or a solar panel. In some examples, one or more of the number of energy sources 222-1, 222-2, . . . , 222-X can be located on a property and/or incorporated into a home. For example, a micro wind turbine could be installed on a property to collect wind energy, a solar panel could be installed on a roof of a home on the property to collect solar energy, and/or hydroelectric energy could be collected using micro turbines in gutters, pipes, and/or sewage lines of the home.

Energy sources 222-1, 222-2, . . . , 222-X can provide data representing an energy input to the computing device 200 in response to the computing device 200 requesting the data representing the energy input, the energy source having energy available, the amount of available energy changing, user specified energy source preferences, the current cost of the energy changing, and/or the predicted cost of the energy changing. The data representing the energy input can include the type of energy source, amount of available energy, and/or the historical, current, and/or predicted cost of the energy.

In some examples, one of the number of energy sources 222-1, 222-2, . . . , 222-X can be a battery. Excess energy generated by the other energy sources of the number of energy sources 222-1, 222-2, . . . , 222-X can be stored in the battery. The computing device 200 can determine that the amount of energy produced by the number of energy sources 222-1, 222-2, . . . , 222-X exceeds the amount of energy needed and/or being consumed by the electrical system 224. In response to determining that the amount of energy produced exceeds the amount of energy needed and/or consumed, the computing device 200 can transmit a command to one or more of the number of energy sources 222-1, 222-2, . . . , 222-X to transmit energy to the battery. In response to determining that the amount of energy produced is less than the amount of energy needed and/or consumed, the computing device 200 can transmit a command to one or more of the number of energy sources 222-1, 222-2, . . . , 222-X to transmit energy to the electrical system 224.

The energy stored in the battery can be for future use by the electrical system 224 and/or to be sold later. For example, a battery can store energy until the other energy sources of the number of energy sources 222-1, 222-2, . . . , 222-X are no longer generating energy and/or no longer generating enough energy for the electrical system 224. In response to the other energy sources of the number of energy sources 222-1, 222-2, . . . , 222-X no longer generating energy and/or no longer generating enough energy for the electrical system 224, the battery can transmit energy to the electrical system 224. In a number of embodiments, the computing device 200 can determine that the other energy sources 222-1, 222-2, . . . , 222-X are no longer generating energy and/or the other energy sources 222-1, 222-2, . . . , 222-X are generating less energy than the electrical system 224 is consuming and send a command to the battery to transmit energy to the electrical system 224.

The computing device 200 using an AI model (e.g., AI model 110 in FIG. 1) can determine a battery target. The battery target can be an amount of stored energy needed to power the electrical system 224 for a particular period of time, for example. The AI model can determine that one energy source of the number of energy sources 222-1, 222-2, . . . , 222-X is a solar panel and will not be generating energy at night, accordingly, the AI model can determine that the battery target is enough energy to power the electrical system 224 from sunset to sunrise.

In some examples, the battery target can change. The AI model can determine that the battery target is four hours because one of the number of energy sources 222-1, 222-2, . . . , 222-X will be down for four hours for scheduled maintenance, accordingly the battery can provide energy to the electrical system 224 for four hours while the other energy source is down for maintenance.

The battery can send data including the amount of energy stored to the computing device 200 in response to reaching a particular threshold, reaching the battery target, and/or in response to receiving a command from the computing device 200. One of the number of energy sources 222-1, 222-2, . . . , 222-X can be an electrical grid. If the battery target is not reached and/or the battery is depleted, the computing device 200 can send a command to the electrical grid to provide energy to the electrical system 224.

In a number of embodiments, the computing device 200, using the AI model, can predict an amount of energy of an energy input prior to receiving the data representing the energy input. For example, weather data can be inputted into the AI model. Forecasts and/or historical weather patterns can be included in the weather data. In response to the weather data including a rain prediction for the next day, the AI model can determine that solar energy generated tomorrow will be minimal. Accordingly, the AI model can determine that a solar panel should transmit and store the solar energy generated today into a battery instead of selling the excess solar energy and transmitting it to an electrical grid, for example. When the energy input from the one or more energy sources 222-1, 222-2, . . . , 222-X exceeds an amount of energy needed by the electrical system 224, the energy input can be transmitted to the electrical grid.

In some examples, one of the one or more energy sources 222-1, 222-2, . . . , 222-X can be a wind turbine. If the weather data includes historical weather data that the coming week has historically been windy and the week following has had low wind then the AI model may determine that the energy generated in the first half of the week should be sold and the energy generated in the second half of the week should be stored and used in the following week.

The computing device 200 using the AI model can determine what energy source and/or energy sources 222-1, 222-2, . . . , 222-X should be used to produce energy output efficiently over a period of time. For example, if energy source 222-1 is a wind turbine, energy source 222-2 is a solar panel, and energy source 222-X is an electrical grid, the AI model can determine to directly use the wind turbine energy on a windy day and directly use the solar panel energy on a sunny day to avoid using energy from the electrical grid. In some examples, the energy source (e.g., a solar panel) can be coupled to an inverter (e.g., a solar inverter) to convert a variable direct current (DC) output of the solar panel into alternating current (AC) for use in a home, for example.

In a number of embodiments, the computing device 200 can send commands to the number of energy sources 222-1, 222-2, . . . , 222-X to prepare for upcoming weather. If weather data includes a forecast of a severe storm, one or more of the number of energy sources 222-1, 222-2, . . . , 222-X can receive a command from the computing device 200 to move to a protective position. For example, the computing device 200 can send a command to a wind turbine to feather its blades or point into the wind to prevent damage to the wind turbine from an incoming storm.

The computing device 200 may communicate and transmit commands to other computing devices, websites, and/or mobile applications. For example, the computing device 200 can manage energy for an eco-friendly hotel. Depending on the time of year the energy sources 222-1, 222-2, . . . , 222-X of the hotel may produce different amounts of energy. For example, the hotel may produce more solar energy in the summer than in the winter. The computing device 200 can determine, based on data representing energy output, energy consumption data of the hotel, user data, data representing news related to local energy consumption, and/or historical and forecasted weather data for a particular period of time, how many guests can stay at the hotel during that particular period of time. The computing device 200 can send a command to the hotel's booking website, for example, to limit the number of room openings during that particular time period based on its determination.

In some examples, the computing device 200 can send commands to the number of energy sources 222-1, 222-2, . . . , 222-X to optimize energy generation. For example, if energy source 222-1 is a solar panel, the position and/or angle of the solar panel can be adjusted. The solar panel can send the energy output data and the position and/or angle of the solar panel to the computing device 200. The computing device 200 can compare the energy output at the position and/or angle to other energy outputs at different positions and/or different angles to determine which position and/or angle provides the most energy output. The other energy outputs, different positions, and/or different angles can be from the same solar panel or from other solar panels. Once the computing device 200 determines the optimal position and/or angle of the solar panel, the computing device 200 can send a command to the solar panel to move to the optimal position and/or angle.

In a number of embodiments, the electrical system 224 can adjust the allocation of energy to an HVAC system, an appliance, an electronic device, a vehicle, a light, a plumbing system, a watering system, a security system, a septic system, a sewer system, and/or any combination thereof in response to a command from the computing device 200. For example, the electrical system 224 can adjust the allocation of energy to a vehicle in response to a command from the computing device 200. The computing device 200 can input user data into an AI model and predict energy usage. The predicted energy usage can be displayed on a user interface (e.g., user interface 106 in FIG. 1). The user data can include historical data of the vehicle battery usage and the user's calendar, for example. The AI model can predict that the vehicle will only use a portion of its battery because the user is only scheduled to drive the vehicle to work, which only takes a portion of its battery according to historical data of the vehicle battery usage. As such, the electrical system 224 can stop charging the vehicle battery when the battery reaches a threshold and energy can be allocated elsewhere or not consumed (e.g., purchased). In some examples, if the energy is a particular type of energy and/or is below a particular price, the AI model may determine to fully charge the vehicle based on a user's constraints, for example.

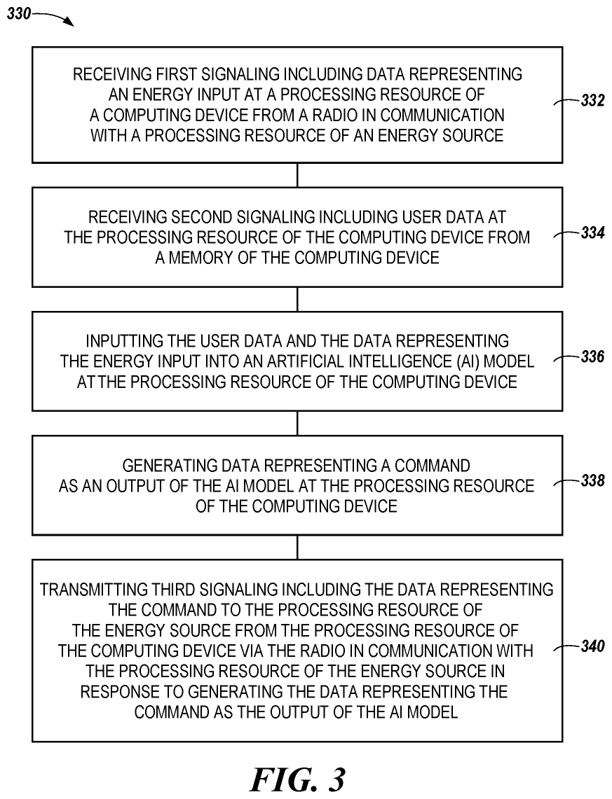

FIG. 3 is a flow diagram of a method 330 for managing energy in accordance with a number of embodiments of the present disclosure. At block 332, the method 330 can include receiving first signaling including data representing an energy input at a processing resource of a computing device from a radio in communication with a processing resource of an energy source. In some examples, the computing device can be a smart assistant, a wearable device, a smartphone, a tablet, a laptop, a desktop computer, or any combination thereof.

An energy source can be, but is not limited to, an electrical grid, a battery, a wind turbine, a micro turbine, or a solar panel. Energy sources can provide energy input data to the computing device. The data representing the energy input can include the type of energy source, amount of available energy, and/or the historical, current, and/or predicted cost of the energy.

At block 334, the method 330 can include receiving second signaling including user data at the processing resource of the computing device from a memory of the computing device. The user data can include, but is not limited to, an amount of energy consumed and/or a frequency of energy consumption of a building, an electrical system, a vehicle, an appliance, an electronic device, an HVAC system, a light, a security system, a watering system, a plumbing system, a sewer system, and/or a septic system.

At block 336, the method 330 can include inputting the user data and the data representing the energy input into an AI model at the processing resource of the computing device. In a number of embodiments, additional and/or different data can be inputted into the AI model. For example, data representing user defined constraints and/or weather data can be inputted into the AI model. Forecasts and/or historical weather patterns can be included in weather data. In some examples, a user can input user defined constraints, such as, an energy spending budget, an energy source preference, or a battery target level.

The user defined constraints can be inputted via a user interface. The user interface can be generated by the computing device in response to one or more commands. The user interface can be a GUI that can provide and/or receive information to and/or from the user of the computing device. In a number of embodiments, the user interface can be shown on a display of the computing device.

At block 338, the method 330 can include generating data representing a command as an output of the AI model at the processing resource of the computing device. The AI model can predict energy usage, predict an amount of energy of the energy input prior to receiving data representing the energy input, determine which energy source to use, generate recommendations, and/or generate commands and output the predictions, determinations, recommendations, and/or commands as a result.

At block 340, the method 330 can include transmitting third signaling including the data representing the command to the processing resource of the energy source from the processing resource of the computing device via the radio in communication with the processing resource of the energy source in response to generating the data representing the command as the output of the AI model. A command can include transmitting an energy input, adjusting an allocation of energy, adjusting a setting of an energy source, and/or adjusting a setting of an electrical system. The command can be transmitted to an energy source, an electrical system, a heating, ventilation, and air conditioning (HVAC) system, an appliance, an electronic device, a vehicle, a light, a plumbing system, sewer system, and/or a septic system, for example.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving first signaling including data representing an energy input at a processing resource of a computing device from a radio in communication with a processing resource of an energy source;
receiving second signaling including user data at the processing resource of the computing device from a memory of the computing device;
inputting the user data and the data representing the energy input into an artificial intelligence (AI) model at the processing resource of the computing device;
generating data representing a command as an output of the AI model at the processing resource of the computing device; and
transmitting third signaling including the data representing the command to the processing resource of the energy source from the processing resource of the computing device via the radio in communication with the processing resource of the energy source in response to generating the data representing the command as the output of the AI model.

2. The method of claim 1, further comprising:
receiving at the processing resource of the computing device fourth signaling including data representing user defined constraints from the memory of the computing device; and
inputting the data representing the user defined constraints into the AI model at the processing resource of the computing device in response to receiving the fourth signaling.

3. The method of claim 1, further comprising:
inputting the user data into the AI model at the processing resource of the computing device;
generating data representing a predicted energy usage as a different output of the AI model at the processing resource of the computing device in response to inputting the user data into the AI model;
transmitting fourth signaling including the data representing the predicted energy usage to a user interface from the processing resource of the computing device via a radio in communication with the user interface in response to generating the data representing the predicted energy usage; and
display the data representing the predicted energy usage on the user interface in response to the user interface receiving the fourth signaling.

4. The method of claim 1, further comprising:
receiving fourth signaling including weather data at the processing resource of the computing device;
inputting the weather data into the AI model at the processing resource of the computing device in response to receiving the fourth signaling; and
generating data representing a predicted amount of energy input prior to receiving the data representing the energy input as a different output of the AI model in response to inputting the weather data.

5. The method of claim 1, further comprising:
determining, at the processing resource of the computing device, the energy input exceeds an amount of energy needed by an electrical system of a building using the AI model;
generating the data representing the command as the output of the AI model in response to determining the energy input exceeds the amount of energy needed by the electrical system of the building; and
the energy source transmitting the energy input to a battery in response to the command from the computing device.

6. The method of claim 1, further comprising:
determining, at the processing resource of the computing device, the energy input exceeds an amount of energy needed by an electrical system of a building using the AI model;
generating the data representing the command as the output of the AI model in response to determining the energy input exceeds the amount of energy needed by the electrical system of the building; and
the energy source transmitting the energy input to an electrical grid in response to the command from the computing device.

7. The method of claim 1, further comprising:
determining, at the processing resource of the computing device, the energy input is less than an amount of energy needed by an electrical system of a building using the AI model;
generating the data representing the command as the output of the AI model in response to determining the energy input is less than the amount of energy needed by the electrical system of the building; and
the energy source transmitting the energy input to the electrical system of the building in response to the command from the computing device.

8. The method of claim 1, further comprising:
receiving fourth signaling including data representing a different energy input at the processing resource of the computing device from a radio in communication with a processing resource of the different energy source;
inputting the user data and the data representing the different energy input into the AI model at the processing resource of the computing device; and
generating data representing a different command as a different output of the AI model at the processing resource of the computing device; and
transmitting fifth signaling including the data representing the different command to the processing resource of the different energy source from the processing resource of the computing device via the radio in communication with the processing resource of the different energy source in response to generating the data representing the different command as the different output of the AI model.

9. The method of claim 8, further comprising the different energy source transmitting the different energy input to an electrical system of a building in response to the different energy source receiving the fifth signaling.

10. An apparatus, comprising:
a memory configured to store:
an artificial intelligence (AI) model;
data representing user defined constraints; and
user data; and
a processor coupled to the memory, wherein the processor is configured to:
receive first signaling including data representing an energy input from a radio in communication with a processor of an energy source;
receive second signaling including data representing the user defined constraints and the user data from the memory;
perform an AI operation by inputting the data representing the energy input, the data representing user defined constraints, and the user data into the AI model;
generate data representing a command as an output of the AI model; and
transmit third signaling including the data representing the command to the processor of the energy source via the radio in communication with the processor of the energy source in response to the output of the AI model.

11. The apparatus of claim 10, further comprising a user interface configured to receive fourth signaling representing the data representing the user defined constraints from a user in response to receiving a selection on the user interface.

12. The apparatus of claim 10, wherein the user interface is configured to:
receive fourth signaling including the data representing the energy input; and
display the data representing the energy input in response to receiving the fourth signaling.

13. The apparatus of claim 10, wherein the user defined constraints include at least one of: an energy spending budget, an energy source preference, or a battery target level.

14. The apparatus of claim 10, wherein the processor is configured to:
receive fourth signaling including at least one of: weather data or data representing news related to local energy consumption; and
perform a different AI operation by inputting at least one of: the weather data or the data representing news related to local energy consumption into the AI model.

15. The apparatus of claim 14, wherein the processor is configured to:
generate data representing a different command as an output of the different AI operation; and
transmit fifth signaling including the data representing the different command to an electrical system via a radio in communication with the electrical system in response to generating the data representing the different command as the output of the different AI operation.

16. A system, comprising:
an electrical system; and
a computing device coupled to the electrical system; wherein the computing device is configured to:
receive first signaling including data representing an energy input at a processing resource of the computing device from a radio in communication with a processing resource of an energy source;
receive second signaling including electrical system data at the processing resource of the computing device from a radio in communication with a processing resource of the electrical system;
perform an artificial intelligence (AI) operation at the processing resource of the computing device by inputting the data representing the energy input and the electrical system data into an AI model;
generate data representing a command as an output of the AI model; and
transmit third signaling including the data representing the command to the electrical system via the radio in communication with the processing resource of the electrical system in response to generating the data representing the command as the output of the AI operation.

17. The system of claim 16, wherein the electrical system is configured to:
receive the third signaling including the data representing the command; and
perform an operation in response to receiving the third signaling including the data representing the command.

18. The system of claim 16, wherein the electrical system is coupled to at least one of: a heating, ventilation, and air conditioning (HVAC) system, an appliance, an electronic device, a vehicle, a light, a security system, a watering system, a plumbing system a sewer system, or a septic system.

19. The system of claim 18, wherein energy allocated to at least one of: the HVAC system, the appliance, the electronic device, the vehicle, the light, the security system, the watering system, the plumbing system a sewer system, or the septic system is adjusted in response to the electrical system receiving the third signaling including the data representing the command.

20. The system of claim 16, wherein the computing device is at least one of: a smart assistant, wearable device, smartphone, tablet, laptop, or desktop computer.
